(19) United States
(12) Patent Application Publication
(10) Pub. No.: US 2026/0277903 A1
(43) Pub. Date: Sep. 17, 2026

(54) DYNAMIC ROW COUNT PREDICTION TECHNIQUE

(71) Applicant: Visa International Service Association, San Francisco, CA (US)

(72) Inventor: Priyanka Balaji, Saligramam, Chennai (IN)

(73) Assignee: Visa International Service Association, San Francisco, CA (US)

(21) Appl. No.: 19/472,155

(22) PCT Filed: Apr. 11, 2023
(86) PCT No.: PCT/US2023/018125

§ 371 Date: Oct. 3, 2025

(51) Int. Cl. G06F 16/2453

(52) U.S. Cl. CPC G06F 16/24545

(57) ABSTRACT

A computer-implemented method of processing a Structured Query Language (SQL query. The method can include identifying a parameter of the SQL query, generating a plurality of input vectors based on the parameter of the SQL query, transmitting the plurality of input vectors to an input layer of a neural network, and receiving a predicted number of rows associated with the input vectors generated by an output layer of the neural network. The predicted number of rows can be generated based on a descent gradient of the neural network. The method can further include modifying the parameter of the SQL query based on the predicted number of rows to generate a modified parameter, wherein the modified parameter is configured to reduce computational resources required to generate an SQL query result, and wherein the modified parameter is configured to improve an accuracy of the SQL query result.

### TECHNICAL FIELD

The present disclosure is generally related to machine learning techniques to enhance query results and, more particularly, is directed to techniques to predict and improve query results based on data types and input conditions.

### SUMMARY

In one aspect, the present disclosure provides a computer-implemented method of processing a Structured Query Language (“SQL”) query. The method can include identifying, by a processor, a parameter of the SQL query, generating, by the processor, a plurality of input vectors based on the parameter of the SQL query, transmitting, by the processor, the plurality of input vectors to an input layer of a neural network, receiving, by the processor, a predicted number of rows associated with the input vectors generated by an output layer of the neural network, wherein the predicted number of rows is generated based on a descent gradient of the neural network, and modifying, by the processor, the parameter of the SQL query based on the predicted number of rows to generate a modified parameter, wherein the modified parameter is configured to reduce computational resources required to generate an SQL query result, and wherein the modified parameter is configured to improve an accuracy of the SQL query result.

In one aspect, the present disclosure provides a system for processing a SQL query. The system can include a dynamic prediction generator including a processor and a memory configured to store a neural network model, and a user device including a processor and a memory, wherein the memory is configured to store instructions that, when executed by the processor, cause the user device to identify a parameter of the SQL query, generate a plurality of input vectors based on the parameter of the SQL query, transmit the plurality of input vectors to an input layer of the neural network, receive a predicted number of rows associated with the plurality of input vectors from an output layer of the neural network, wherein the predicted number of rows is generated based on a descent gradient of the neural network and a hidden state generated by an intermediate layer of the neural network, and modify the parameter of the SQL query based on the predicted number of rows to generate a modified parameter, wherein the modified parameter is configured to reduce computational resources required to generate an SQL query result, and wherein the modified parameter is configured to improve an accuracy of the SQL query result.

In one aspect, the present disclosure provides a computer-implemented method of processing SQL query. The method can include receiving, by an input layer of a neural network, a plurality of input vectors based on a parameter of the SQL query, converting, by an intermediate layer of the neural network, the plurality of input vectors into a hidden state based on a plurality of randomly initialized weights, wherein the plurality of randomly initialized weights are determined based on a descent gradient of the neural network, and generating, by an output layer of the neural network, a predicted number of rows based on the hidden state, generating a recommendation to modify the SQL query based on the predicted number of rows, and transmitting the recommendation to a processor, wherein an implementation of the recommendation improves the SQL query result.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses, systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a block diagram of a system configured to generate a query output prediction, according to at least one aspect of the present disclosure;

FIG. 2 illustrates a block diagram of a neural network model configured to be executed by the system of FIG. 1, according to at least one aspect of the present disclosure;

FIG. 3 illustrates a flow diagram of a method of generating a query output prediction, according to at least one aspect of the present disclosure;

FIG. 4 illustrates a logic flow diagram of a method of retraining the neural network model of FIG. 2 based on an output predicted via the method of FIG. 3, according to at least one aspect of the present disclosure;

FIG. 5 illustrates a computer-implemented method of processing a query, according to at least one aspect of the present disclosure;

FIG. 6 illustrates another computer-implemented method of processing a query, according to at least one aspect of the present disclosure;

FIG. 7 illustrates a block diagram of a computer apparatus with data processing subsystems or components, according to at least one aspect of the present disclosure; and

FIG. 8 illustrates a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific aspects, or examples, some descriptions of terms used herein are provided below.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting aspects, a message may refer to a packet (e.g., a data packet, a network packet, and/or the like) that includes data. It will be appreciated that numerous other arrangements are possible.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

As data is increasingly tracked, managed and accessed for a variety of personal and commercial applications, databases are become increasingly complex. For example, corporate databases can contain thousands of tables, and a simple “search by name” may not efficiently return the intended result. Knowing how to locate the desired entry within an extremely large database schema can be both difficult and resource intensive. Therefore, database designers, are continually seeking improved—and more importantly, efficient—techniques to identify the right entries from the right objects within a complex database schema.

Structured Query Language (SQL) has emerged as a specialized language for updating, deleting, and requesting information from databases and has been adopted as an ANSI and ISO standard for database queries. Although the language in which queries are generated has been standardized, a significant amount of user-driven errors remain, based on how a user assembles a query. In other words, the quantity and quality of results may vary based on how the query is framed by the user. For example, if certain conditions are not applied correctly in a query, the query may not return the expected number of rows. This is because query results generally depend on the type of data chosen and the conditions implied by the user. If the user does not include the appropriate data type and/or conditions, the results may not be accurate or, alternately and/or additionally, may be of a large size such at the expense of computational resources required to process the query, which can waste both time and money.

Often, an improperly formatted query may not return any data at all. Worse, the user, may not be made aware of the type of result returned until after the query has completed running—which can take hours depending on the query format. Only after the result is returned can the user attenuate the underlying conditions and components of the query and run the report again. The problem is exacerbated as the query increases in complexity and length. In summary, conventional devices, systems, and methods are not configured to generate a baseline expectation for query results and thus, present a technological hurdle for developers seeking to proactively reduce the amount of computational resources required to process sub-optimal queries. Accordingly, there is a need for dynamic prediction techniques, e.g. dynamic row count, or hit count, prediction technique, that will inform and improve the structure of a query, improve the quality of results, and reduce the amount of computational resources required to achieve those results.

Such techniques might include the implementation of an algorithmic method for pre-processing a query, the results of which include a baseline expectation for query results based on past-queries that have been pre-processed. Thus, the devices, systems, and methods disclosed herein enable a user to predict query results without having to invest the time, money, and computational resources to execute the request. The method, for example, may implicate a neural network model to predict an output or characteristic of an output, including, for example, predicting a number of rows, or hits, that might be generated in response to the query.

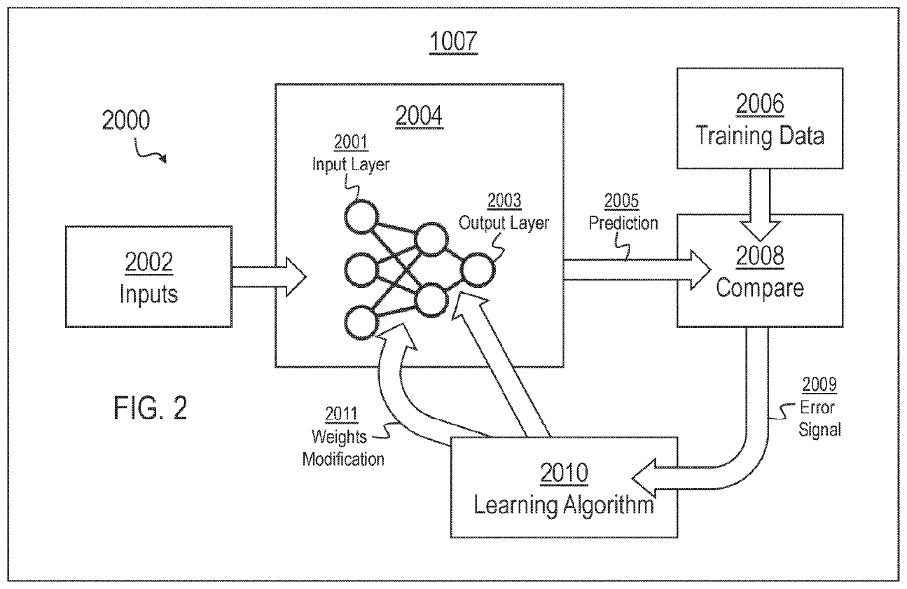

Based on the generated predictions, the devices, systems, and methods disclosed herein may further implement a mathematical function to train the neural network model. In at least one example, the devices, systems, and methods disclosed herein may implement a mean absolute percentage error (MAPE) to train the neural network model. For example, the MAPE may be calculated by taking an average of the quotient of the difference between the characteristic of the actual query result and the characteristic of the query result predicted via the neural network model 2000 of FIG. 2, when divided by the characteristic of the actual query result

$$( e . g . , MAPE = AVG ( \frac{Actual - Predicted}{Actual} ) ) ,$$

wherein “AVG” includes the calculation of an average of the values within the parentheses, wherein “Actual” includes the actual output of the query, and wherein “Predicted” includes the predicted output of the query generated by the neural network model 2000 of FIG. 2. assuming the predicted and actual characteristics of the query output are quantifiable metrics (e.g., number of rows, etc.).

Accordingly, the devices, systems, and methods disclosed herein can be configured to continuously improve the accuracy and precision of results generated by the algorithmic method, such that query attenuations are perfected in time. According to some non-limiting aspects of the present disclosure, the devices, systems, and methods disclosed herein can be configured to autonomously provide proposed modifications for a query, which will yield even more precise, more accurate results that will occupy even less computational resources. According to other non-limiting aspects of the present disclosure, the devices, systems, and methods disclosed herein can be configured to autonomously modify the query based on the proposed modifications.

As such, it shall be appreciated that the devices, systems, and methods disclosed herein are particularly configured to present technological solutions to the aforementioned technological problems. Specifically, the devices, systems, and methods disclosed herein are configured to pre-process one or more queries and provide a preliminary characterization of predicted outputs (e.g., a predicted number of rows), as well as suggested improvements to the query, enabling the user to enhance the accuracy and precision of the generated output and generate the output using less computational resources. For example, the devices, systems, and methods disclosed herein can preliminarily validate data types (e.g., integer, character, money, date and time, binary, etc.) and conditions (e.g., compound conditions, floating-point conditions, group comparison conditions, logical conditions, range conditions, etc.) before resources are ever expended. For example, according to some non-limiting aspects, the validation can be “preliminary” in the sense that it is performed prior to execution of the query. However, according to other non-limiting aspects, the validation can take place in parallel to the execution of the query. According to still other non-limiting aspects, the validation can be time-based or based on a number of results. Moreover, the devices, systems, and methods disclosed herein can generate suggested modifications of the initially selected data types and conditions, and, in some instances, can autonomously implement changes to the query prior to execution. Moreover, the devices, systems, and methods disclosed herein can significantly improve the operational efficiency of conventional systems at a scale, which is increasingly important for large, complex database schema. The ability to efficiently operate at scale further underscores and distinguishes the capabilities of the devices, systems, and methods disclosed herein beyond those of a single developer or team of developers. Because the devices, systems, and methods disclosed herein can predict query outputs and improve queries based on those predicted outputs without having to execute the queries, even a team of developers would require a large number of computational resources to generate the insights and improvements provided by the devices, systems, and methods disclosed herein. Accordingly, the devices, systems, and methods disclosed herein improve conventional technologies and provide practical, tangible results that would otherwise be unattainable to developers.

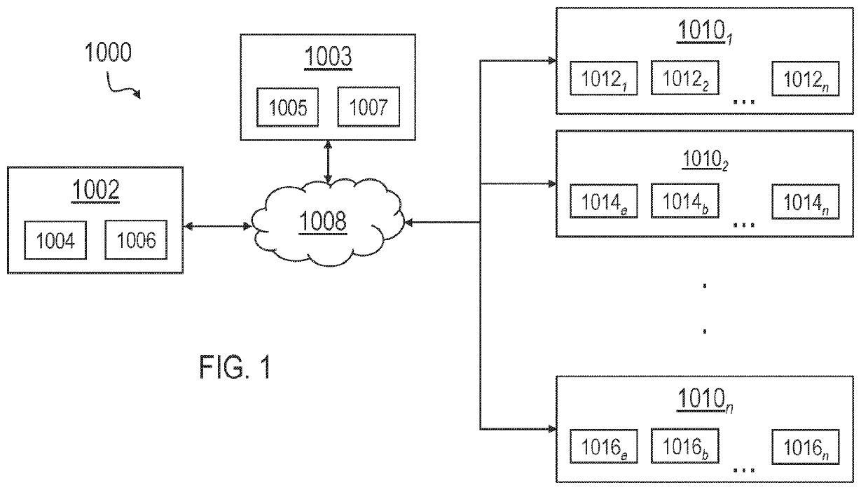

Referring now to FIG. 1, a block diagram of a system 1000 configured to generate a query output prediction is depicted according to at least one aspect of the present disclosure. According to some non-limiting aspects, the query can be an SQL query and the output prediction or predicted SQL query result, for example, can include an anticipated number of rows, or hits, of the expected output. However, as will be described in further detail herein, according to other non-limiting aspects, the system 1000 can be configured to generate other output predictions for queries scripted in a number of different languages. According to the non-limiting aspect of FIG. 1, the system 1000 can include a user device 1002, a dynamic prediction generator 1003, and a plurality of data sources 1010ₐ₋ₙ communicably coupled via a communications network 1008. For example, the communications network 1008 can include any means of wired communications (e.g., local area network, ethernet, fiber optic, etc.) and/or any means of wireless communications (e.g., wireless local area network, WiFi, Cellular, Bluetooth, Zigbee, Near-Field Communications, etc.)

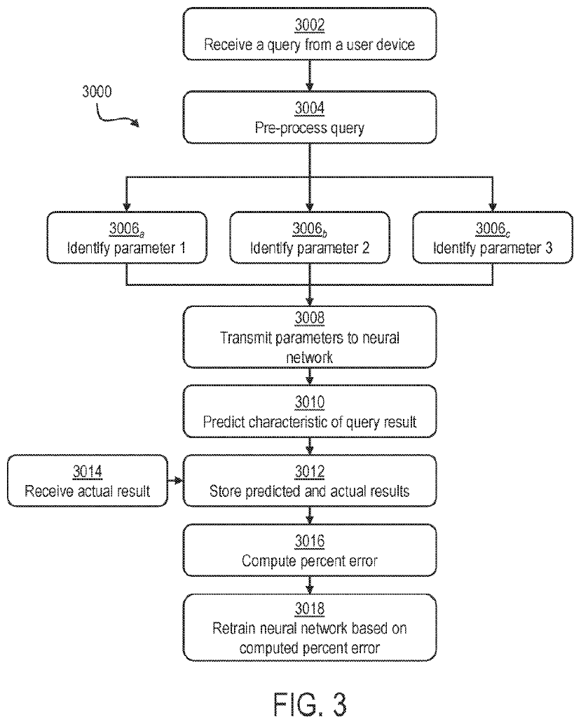

It shall be appreciated that the dynamic prediction generator 1003 of the system 1000 of FIG. 1 can include any computing device (e.g., a laptop, a personal computer, a server, a smart phone, a tablet, a wearable, etc.) with a processor 1005 and a memory 1007 configured to perform any of the methods 2000 (FIG. 2), 3000 (FIG. 3) disclosed herein. Likewise, the user device 1002 can include any computing device (e.g., a laptop, a personal computer, a server, a smart phone, a tablet, a wearable, etc.) with a processor 1004 and a memory 1006. For example, according to some non-limiting aspects, the memory 1007 of the dynamic prediction generator 1003 can be configured to store one or more algorithms and/or models that, when executed by the processor 1005, cause the dynamic prediction generator 1003 to perform one or more steps of the methods disclosed herein.

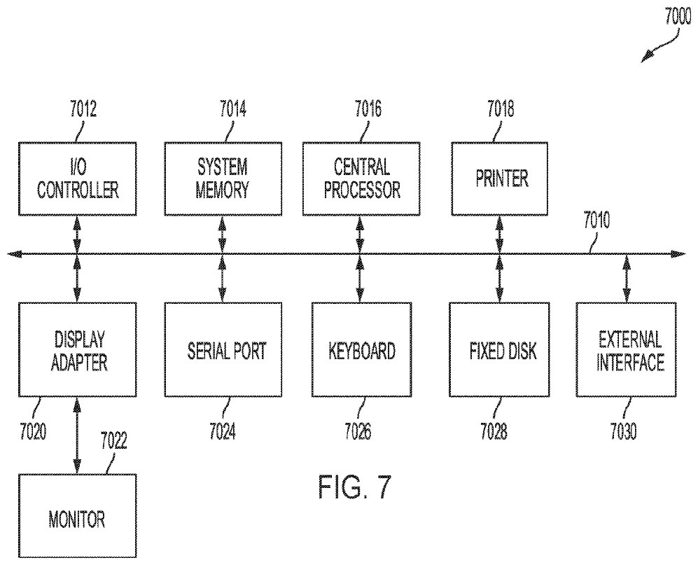

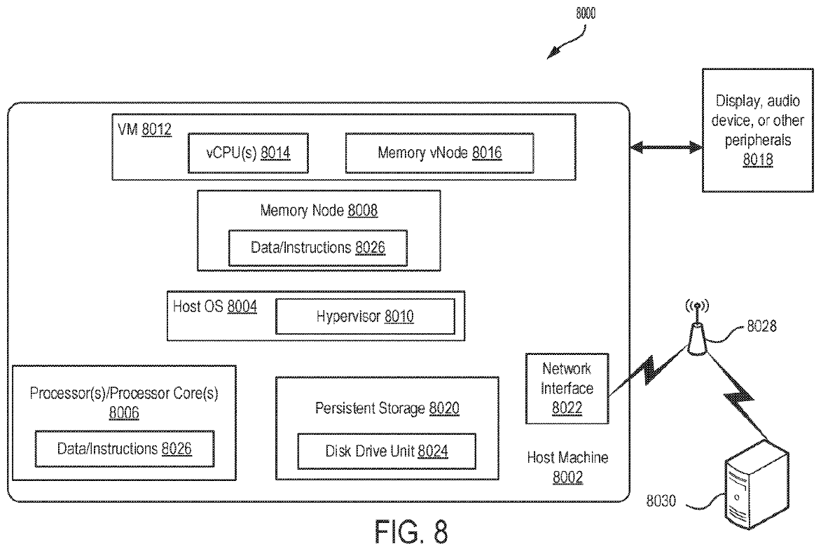

Although the non-limiting aspect of FIG. 1 illustrates a large number of data sources 1010ₐ₋ₙ—to emphasize the ability of the system 1000 to pre-process queries efficiently at scale—it shall be appreciated that, according to some non-limiting aspects, the system 1000 can include a single data source 1010a. It shall be further appreciated that, any of the components 1002, 1003, 1010₁₋ₙ of the system 1000 can include at least one of the computer apparatus 7000 of FIG. 7 and/or the host machine 8002 of FIG. 8, either of which may be specifically configured to perform one or more steps of the methods disclosed herein. Additionally, although system 1000 of FIG. 1 includes a single block representing the user device 1002, the dynamic prediction generator 1003, and each of the plurality of data sources 1010ₐ₋ₙ, it shall be appreciated that, according to some non-limiting aspects, the user device 1002, the dynamic prediction generator 1003, and each of the plurality of data sources 1010ₐ₋ₙ, can include two or more devices, computers, and/or servers configured to perform the functions disclosed herein.

One or more data sources 1010ₐ₋ₙ of the system 1000 of FIG. 1 can be configured as a relational database, or a database configured to store and provide access to system objects 1012ₐ₋ₙ, 1014ₐ₋ₙ, 1016ₐ₋ₙ that are related to one another. Accordingly, each data source 1010, of the plurality of data sources 1010₁₋ₙ can include on or more system objects 1012ₐ₋ₙ, 1014ₐ₋ₙ, 1016ₐ₋ₙ, or a data structure (e.g., tables, forms, reports, etc.) configured to either store or reference data. However, according to some non-limiting aspects, the system 1000 can employ system objects 1012ₐ₋ₙ, 1014ₐ₋ₙ, 1016ₐ₋ₙ such as schemas, journals, catalogs, aliases, views, indexes, constraints, triggers, sequences, stored procedures, user-defined functions, user-defined types, global variables, and/or SQL packages.

In summary, the system 1000 of FIG. 1 is configured to generate and/or process queries, which can enable a user to access and/or manipulate data stored in the system objects 1012ₐ₋ₙ, 1014ₐ₋ₙ, 1016ₐ₋ₙ stored in each of the plurality of data sources 1010₁₋ₙ. In this way, the system 1000 of FIG. 1 can utilize queries to store, update, remove, search, and retrieve information from the data sources 1010₁₋ₙ. The system 1000 can also be configured to maintain and optimize performance of each of the data sources 1010₁₋ₙ. For example, according to one non-limiting aspect, the system 1000 of FIG. 1 can be used to generate and/or process SQL queries, because SQL integrates well with different programming languages. For example, SQL queries can be embedded within a Java programming language to build high-performing data processing applications with major SQL database systems. SQL is also fairly easy to learn as it uses common English keywords in its statements. However, it shall be appreciated that, according to other non-limiting aspects, the system 1000 of FIG. 1 can be configured to generate and process queries scripted in alternate languages, such as SchemeQL, LINQ, ScalaQL, ScalaQuery, SqlStatement, ActiveRecord, and/or HaskellDB, amongst others. In other words, the methods 200, 300 disclosed in reference to FIGS. 2 and 3 can be employed by the system 1000 of FIG. 1 to pre-process and modify queries in a variety of different languages, not only SQL.

In further reference to FIG. 1, the user device 1002 can be configured to receive a query via a user interface of the user device 1002. It shall be appreciated that a particular query can be saved by the user device 1002 as a procedure configured to be called and executed numerous times. The query can include one or more user-defined variables and/or parameters. According to some non-limiting aspects, a variable can be configured to hold one or more data values of a specific type. According to some non-limiting aspects, a parameter can be configured to exchange data among stored procedures and functions initiated when the query is processed by the dynamic prediction generator 1003. A variable can be assigned an identifying name and/or either a system-supplied or user-defined data type and a length. An input parameter can be configured to pass a data value to a stored procedure or function. An output parameter can be configured to pass a data value back to the caller, or user device 1002. In summary, it shall be appreciated that variables and parameters of a query are configured for different uses in the system 1000 of FIG. 1.

A query or procedure generated by the user device 1002 of the system 1000 of FIG. 1 can include a user or system 1000 specified parameter, such as a name, a data type, and/or a direction. According to some non-limiting aspects, parameters can be assigned default values. Each parameter attribute can be configured for a different use during a query or procedure call and thus, modifying the attributes of a parameter can alter the efficacy and/or efficiency of a query and/or procedure. For example, a data type is an attribute of a query and/or procedure that searches for a specific type of data (e.g., integer data, character data, monetary data, date and time data, binary strings, etc.) stored by an object 1012ₐ₋ₙ, 1014ₐ₋ₙ, 1016ₐ₋ₙ. According to one non-limiting aspect, each data source 1010, of the plurality of data sources 1010₁₋ₙ can supply a set of system data types that define all the types of data that can be used with that particular data source 1010ₙ.

Alternately or additionally, a query or procedure generated by the user device 1002 of the system 1000 of FIG. 1 can include a conditional statement configured to define a logic executed based on whether the defined condition is satisfied. For example, according to some non-limiting aspects, a condition of a query can include one or more expressions and logical operators (e.g., binary logics, such as Boolean logic, trinary logics, sentential logics, Kleene logic, and/or Priest logic, etc.) configured to return a value (e.g., TRUE, FALSE, unknown, etc.) for at least a component of a query or procedure. For example, a condition can include conventional conditions (e.g., IF, CASE, SELECT, INFULL, etc.), compound conditions (e.g., EQUALS_PATH, EXISTS, etc.), floating-point conditions (e.g., expr IS, etc.), group comparison conditions (e.g., IN, IS A SET, IS ANY, IS EMPTY, IS OF TYPE, IS PRESENT, LIKE, etc.), logical conditions (e.g., MEMBER, NULL, etc.), range conditions (e.g., REGEXP_LIKE, etc.), and/or simple comparison conditions (e.g., SUBMULTISET, UNDER_PATH, etc.), amongst others. In other words, parameters of a query, such as a condition statement, can enable a user to employ logical operations via a query. Thus, condition statements add complexity to a query that provides additional functionality, but can alter the means by which the query changes and views information within a data source 1010₁₋ₙ.

As previously discussed, the types and/or combinations of parameter attributes of a query can determine the efficacy and/or efficiency with which the system 1000 of FIG. 1 processes the query and returns results. Accordingly, the system 1000—and more particularly, the dynamic prediction generator 1003—can be particularly configured to pre-process a query received from the user device 1002. Specifically, the dynamic prediction generator 1003 can employ the algorithmic methods disclosed herein to pre-process a query received from the user device 1002 to predict and/or otherwise characterize an estimated result of the query. Such predictions can serve as a baseline expectation for query results based on past-queries that have been processed and/or pre-processed by the system 1000 and, according to some non-limiting aspects, can generate parameter modifications for the query to improve the accuracy, precision, and efficiency of the results generated when processed. The system 1000 can produce these benefits without requiring an investment of time, money, and/or computational resources to fully process the query.

Referring now to FIG. 2, a block diagram of a neural network model 2000 configured to be executed by the system of FIG. 1 is depicted in accordance with at least one non-limiting aspect of the present disclosure. Specifically, the neural network model 2000 can be stored in the memory 1007 of the dynamic prediction generator 1003 of the system 1000 of FIG. 1, and configured to generate a prediction, including a characterization of a predicted result (e.g., a quantity of rows that will be returned when the query is processed). According to some non-limiting aspects, the dynamic prediction generator 1003 of the system 1000 of FIG. 1 can employ the neural network model 2000 to transmit the predicted results for receipt via the processor 1004 of the user device 1002 of the system 1000 of FIG. 1. Accordingly, the user device 1002 can be configured to display the predicted results to a user of the system 1000 of FIG. 1, provide generated recommendations for query modifications that will improve the actual efficiency and results of the query, and/or autonomously implement query modifications to improve the actual efficiency and results of the query.

Additionally, according to the non-limiting aspect of FIG. 2, the neural network model 2000 can include a multi-layer preceptron (MLP) model 2004, which is a feedforward neural network that includes a plurality of layers (e.g., an input layer 2001, an output layer 2003) configured to generate one or more outputs (e.g., a predicted output 2005) from a set of inputs 2002. Although the neural network model 2002 of FIG. 2 is a MLP, it shall be appreciated that, according to other non-limiting aspects of the present disclosure, other neural network models can be implemented to similar effect, including Long Short-Term Memory Networks, Convolutional Neural Networks, and/or Recurrent Neural Networks, amongst others.

In further reference to the non-limiting aspect of FIG. 2, inputs 2002 to the neural network model 2000 can include a query, an identified parameter of a query, and/or training data 2006, amongst other inputs necessary to characterize the predicted results of a query and/or improve the performance of the neural network model 2000 itself. Alternately, the processor 1005 of the dynamic prediction generator 1003 of the system 1000 of FIG. 1 can pre-process a query via the method 3000 of FIG. 3 and provide one or more identified parameters 3006_{a-c} to the neural network model 2000 as inputs 2002. For example, the processor 1005 (FIG. 1) can generate one or more of input vectors based on the identified parameters, wherein the one or more input vectors are specifically formatted for receipt via the input layer 2001 of the neural network model 2000. According to some non-limiting aspects, an input array can be generated and converted into vectors via embedding vectors. It shall be appreciated that vector embeddings can include a list of numbers representing many types of data, including the query and query parameters.

Based on those inputs 2002, the input layer 2001 of the neural network model 2000 of FIG. 2 can be configured to convert the one or more input vectors to a hidden state based on a plurality of randomly initialized weights. The hidden state, for example, can be processed via one or more intermediate layers of the neural network model 2000 positioned between the input layer 2001 and the output layer 2003. These intermediate layers, as well as their inputs and outputs (e.g., hidden states) are considered “hidden” because they are not directly observable from the inputs 2002 and outputs 2005 of the neural network model 2000. Nevertheless, the hidden state is generated by the intermediate layers of the neural network model 2002 based on randomly initialized weights configured to converge the inputs 2002 into an output 2005 with a desired accuracy and precision.

Still referring to FIG. 2, once the hidden states are processed by the output layer 2003 of the neural network model 2000, the output layer 2003 can be configured to generate one or more outputs 2005, which it can transmit for receipt via the processor 1005 of the dynamic prediction generator 1003. As previously described, the output 2005 can include a characterization of a predicted output, including but not limited to a predicted number of rows of the output, as well as proposed modifications to the parameters of the query that will improve the actual efficiency and results of the query. The dynamic prediction generator 1003 (FIG. 1) can be configured to transmit the output 2005, including the predicted results and modifications to the processor 1004 of the user device 1002 of the system 1000 of FIG. 1 for analysis and/or implementation.

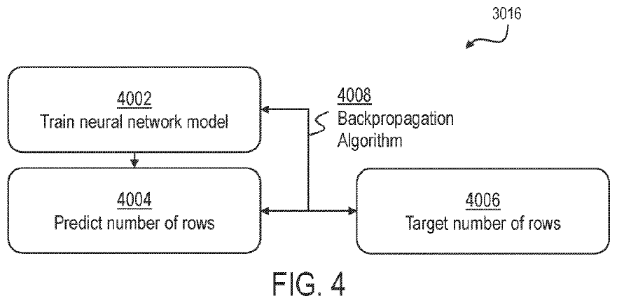

According to the non-limiting aspect of FIG. 2, the dynamic prediction generator 1003 of FIG. 1 can be further configured to perform a comparison 2008 of the predicted output 2005 generated by the neural network model 2000 to the actual results, or at least a portion of the actual results, generated when the system 1000 runs the query, which can be provided back to the dynamic prediction generator 1003 as training data 2006. Based on this training data 2006, the dynamic prediction generator 1003 can be configured to generate an error signal 2009. For example, the dynamic prediction generator 1003 of FIG. 1 can calculate a MAPE, which is configured to characterize the accuracy of the output 2005 generated by the neural network model 2000. Of course, the present disclosure contemplates other non-limiting aspects wherein alternate means of characterizing the accuracy of the output 2005 are employed. The error signal 2009 is provided as an input to a learning algorithm stored in the memory 1007 of the dynamic prediction generator 1003 of the system 1000 of FIG. 1, which can generate a weight modification 2011 that modifies the weights by which the neural network model 2002 generates the hidden state, which determines the accuracy the of the generated output 2005. In other words, as will be described in more detail in reference to FIG. 4, the dynamic prediction generator 1003 of FIG. 1 can be configured to adjust the randomly initialized weights based on an optimized descent gradient. It shall be appreciated that adjusting the randomly initialized weights can improve an accuracy of a predicted result or output characterization (e.g., the predicted number of rows). Accordingly, the dynamic prediction generator 1003 of FIG. 1 can employ the neural network model 2000 of FIG. 2 to continuously improve the quality of the generated outputs 2005, including more accurate predictions of query results and improved parameter modifications configured to further enhance the accuracy and efficiency of the future queries.

Referring now to FIG. 3, a logic flow diagram of a method 3000 of generating a query output prediction, according to at least one aspect of the present disclosure. The method 3000 of FIG. 3 can be performed by one or more components of the system 1000 of FIG. 1. For example, according to the non-limiting aspect of FIG. 3, the method 3000 can include receiving 3002 a query. The query may be generated by a user via the processor 1004 of the user device 1002 of FIG. 1 and received via the processor 1005 of the dynamic prediction generator 1003 of FIG. 1. Upon receiving 3002 the query, the method 3000 can further include pre-processing 3004 the query via the processor 1005 of the dynamic prediction generator 1003 of FIG. 1. According to some non-limiting aspects, pre-processing 3004 the query can involve one or more natural language processing (NLP) libraries (e.g., Natural Language Toolkit (e.g., NLTK, etc.) and/or Regular Expressions (e.g., Python, etc.), either of which can assist the dynamic prediction generator 1003 of FIG. 1 in understanding the meaning, tone, context, and/or intent of a desired query output. For example, the Regular Expression can include a sequence of characters that forms a search pattern configured to confirm whether one or more objects 1012ₐ₋ₙ in one or more data sources 1010₁₋ₙ of FIG. 1 includes the specified search pattern. In other words, pre-processing 3004 the query includes a certain degree of sentiment analysis configured to enhance the generated output prediction. Pre-processing 3004 the query can include identifying 3006a-c one or more parameters or characteristics of the query. For example, the one or more parameters can include a selection of one or more data sources 1010₁₋ₙ (e.g., [table1, table2], etc.) of FIG. 1, one or more conditions (e.g., [condition1, condition2], etc.), and/or one or more requests for display (e.g., [display1, display2], etc.), amongst other parameters. The method 3000 can subsequently transmit 3008 the one or more identified parameters into an input layer of a neural network model, such as the neural network model 2000 of FIG. 2.

It shall be further appreciated that, according to other non-limiting aspects, the method 3000 of FIG. 3 can include generating and pre-processing 3004 the query by the processor 1004 of the user device 1002 of FIG. 1, and transmitting the one or more identified parameters to a neural network model 2000 (FIG. 2) stored in the memory 1007 of the dynamic prediction generator 1003 of FIG. 1. Regardless of which system 1000 component performs the pre-processing 3004, the method 3000 can include predicting 3010, via the neural network model 2000 (FIG. 2), a characteristic of a query output or result based on the one or more identified parameters, such as a predicted number of rows of an anticipated query output. As previously discussed, the number of rows returned by a query can be indicative of the amount time and/or computing resources required to process and respond to the query. However, it shall be appreciated that, according to other non-limiting aspects, the method 3000 can be configured to predict other characteristics of an anticipated query output.

For example, if the method 3000 of FIG. 3 predicts that a query will return a large number of hits, the dynamic prediction generator 1003 (FIG. 1) may determine that the query, in its original form, may require a large amount of time to process, require a large number of computing resources to process, and/or generate a suboptimal result (e.g., inaccurate, no result, etc.). Thus, according to some non-limiting aspects, the method 3000 can include generating, via the dynamic prediction generator 1003 and/or other components of the system 1000 of FIG. 1, one or more suggested modifications to the original query, which can be configured to alter the predicted characteristics of the output and thus, require less time to process, require less computing resources to process, and/or generate a more optimal result (e.g., more accurate, etc.), relative to the original query. According to other non-limiting aspects, the method 3000 can include autonomously implementing, via the dynamic prediction generator 1003 and/or other components of the system 1000 of FIG. 1, the one or more suggested modifications to the original query. However, according to still other non-limiting aspects, the method 3000 can include transmitting, via the dynamic prediction generator 1003 and/or other components of the system 1000 of FIG. 1, the one or more suggested modifications to the original query to the user device 1002 for implementation via the user. For example modifications to the query can include, modifying the conditions to make the result set more precise, modifying the columns to be displayed to fetch fewer number of rows and columns, which can make the query run faster, and/or changing the query in case the predicted number of rows is not as expected.

In further reference to FIG. 3, the method 3000 can further include receiving 3014 an actual result after the original query is processed and storing 3012 both the predicted result and actual result, for example, in the memory 1007 of the dynamic prediction generator 1003 of FIG. 1. Accordingly, the method 3000 can subsequently include computing 3016 a percent error of the predicted result based on the predicted result and actual results. For example, as previously discussed, the dynamic prediction generator 1003 of FIG. 1 can calculate a MAPE, which is configured to characterize the accuracy of the predicted output, as generated by the neural network model 2000 of FIG. 2, or any other means of characterizing the accuracy of the output 2005 are employed. Based on the calculated error, the method 3000 can include computing 3016 a percent error associated with a predicted output generated by the neural network model 2000 of FIG. 2. For example, as previously discussed, the calculated error can be used to modify the weights by which the neural network model 2002 of FIG. 2 generates the hidden state, which determines the accuracy the of the predicted output and characterization thereof. Accordingly, the method 3000 of FIG. 3 can be executed by one or more components of the system 1000 of FIG. 1 and the neural network model 2000 of FIG. 2 to continuously improve the quality of the predicted outputs.

For example, according to some non-limiting aspects, the method 3000 of FIG. 3 is implemented to pre-process a SQL query, such as: “select id, name from employee where tlt=‘Data and AI Platform.’” During the pre-processing 3004 step, the method 3000 may identify a first parameter associated with a data object 1012ₙ, 1014ₙ, 1016ₙ (e.g., a table to be used) of a data source 1010₁₋ₙ table to be queried (e.g., [employee], etc.), a second parameter associated with a condition to be applied by the query (e.g., [tlt, equal to, ‘Data and AI Platform’], etc.), and or a desired output (e.g., [id, name], etc.) of the query. As such, predicting 3010 a characterization of the output can include an array of information.

Referring now to FIG. 4, a logic flow diagram of a method 4000 of retraining the neural network model 2000 of FIG. 2 based on an output predicted via the method 3000 of FIG. 3 is depicted according to at least one aspect of the present disclosure. According to the non-limiting aspect of FIG. 4, the method 4000 of retraining the neural network model 2000 of FIG. 2 can include use of a backpropagation algorithm and stochastic gradient descent, amongst other means of training the neural network model 2000 by adjusting one or more weights applied via one or more layers of the neural network model 2000, as described in reference to FIG. 2. Once the pre-processing 3004 and parameter identifying 3006 steps of the method 3000 of FIG. 3 have produced one or more query parameters (e.g., tables, conditions, etc.), and the pre-processing 3004 step has produced the actual results, the method 4000 of FIG. 4 can be implemented to retrain the neural network model 2000 of FIG. 2.

For example, according to some non-limiting aspects, the method 4000 of FIG. 4 can include the use of a stochastic gradient descent optimization algorithm to minimize the loss of predictions generated by the neural network model 2000 of FIG. 2 model based on a training dataset. It shall be appreciated that gradient descent is performed via an optimization algorithm configured to identify sets of input variables for a target function, which can result in a minimum value of the target function. The gradient descent algorithm computes a gradient of the target function with respect to the specific values of the input values, pointing “uphill,” meaning the negative of the gradient of each input variable is followed “downhill” to result in a new value for each variable. This produces a lower evaluation of the target function. A step size is used to scale the gradient and control how much to change each input variable with respect to the gradient. The gradient descent algorithm can be configured to repeat this process until the minimum of the target function is identified, a maximum number of solutions are evaluated, and/or another stop condition is achieved. It shall be further appreciated that stochastic gradient descent can include an adaption of the aforementioned gradient descent approach to minimize the loss function of a prediction generated by the neural network model 2000 of FIG. 2, based on the training dataset via a classification and/or regression model.

According to the non-limiting aspects of FIG. 4, the method 4000 of FIG. 4 can further include the use of a backpropagation algorithm configured to compute the gradient of a loss function with respect to variables of a model. Backpropagation can be used when training the neural network model 2000 of FIG. 2 to calculate the gradient for each weight applied via the various layers of the neural network model 2000. The gradient can subsequently be used by an optimization algorithm to update the model weights. A loss function can represent the error of the neural network model 2000 of FIG. 2, or the error function. Thus, the weights are the variables for the function, and the gradients of the error function with regard to the weights are therefore referred to as error gradients. Specifically, a backpropagation algorithm can be configured to compute the gradients recursively backward through the neural network model 2000 of FIG. 2 starting at the output layer 2003 via the recursive application of the chain rule, thereby generating a derivative of a sub-function. In other words, the backpropagation algorithm can be used to calculate the gradient used by the stochastic gradient descent optimizer to minimize the error between the predicted and target value (calculated # of rows from training data). This can be used to train to adjust the weights and provide more accuracy to the predicted output.

Based on the backpropagation and stochastic gradient descent techniques described above, it shall be appreciated that the method 4000 of FIG. 4 can include training 4002 the neural network model 2000 of FIG. 2. Once trained, the method 4000 can include predicting 4004 an output and/or output characteristic (e.g., predicted number of rows, etc.) via the neural network model 2000 of FIG. 2. Based on the prediction, the method 4000 can include targeting 4006 an output characteristic (e.g., targeted number of rows, etc.) via the aforementioned target function of the gradient descent algorithm. Thus, the backpropagation and stochastic gradient descent techniques described above can be used to generate and implement an optimized descent gradient configured to minimize an error between the predicted number of rows and a target value number of rows that is generated based on training data provided to the neural network model 2000 of FIG. 2.

Via the backpropagation algorithm, the method 4000 of FIG. 4 can further include adjusting 4008 the weights of the neural network model 2000 of FIG. 2, thereby improving the accuracy of future predictions generated by the neural network model 2000. In other words, the adjustment of the randomly initialized weights can be based on a descent gradient, which is optimized via the gradient descent algorithm to improve an accuracy of the predicted result or characterized output (e.g., the predicted number of rows, etc.). As the neural network model 2000 generates subsequent predictions, the dynamic prediction generator 1003 of FIG. 1 (or any other system 1000 component hosting and executing the neural network model 2000 of FIG. 2) can assess whether the calculated error (e.g., the MAPE, etc.) exceeds a predetermined threshold. For example, if the calculated error is greater than or equal to ten percent, the dynamic prediction generator 1003 of FIG. 1 (or any other system 1000 component hosting and executing the neural network model 2000 of FIG. 2) may be configured to re-perform the method 4000 of retraining the neural network model 2000 of FIG. 2.

After the method 4000 of FIG. 4 is complete, one or more components of the generated output can be stored in the memory 1007 of the dynamic prediction generator 1003, and/or any other memory or database communicably coupled to the system of FIG. 1. For example, the system 1000 of FIG. 1 may be configured to store a unique identifier associated with the processed query, a characterized output (e.g., predicted number of rows, etc.) associated with the query, an actual output (e.g., actual number of rows, etc.) associated with the query, one or more particular data sources 1010₁₋ₙ (e.g., tables, etc.) used by the query, one or more conditions applied by the query, and/or one or more displayed outputs generated by the query. It shall be appreciated that such information can be useful to compute future MAPEs, re-train the neural network model 2000 of FIG. 2, and might be beneficial for future reference.

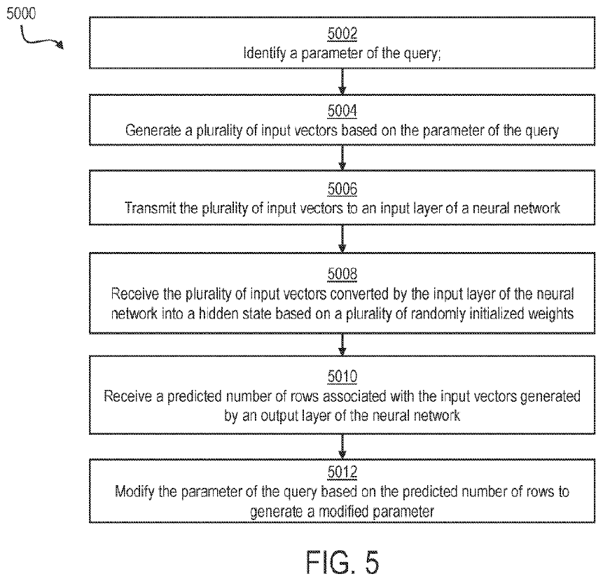

Referring now to FIG. 5, a computer-implemented method 5000 of processing a query is depicted in accordance with at least one aspect of the present disclosure. For example, the method 5000 can be performed via the processor 1004 of the user device 1002 of the system 1000 of FIG. 1. However, according to other non-limiting aspects, one or more steps of the method 5000 of FIG. 5 can be performed by any other components of the system 1000 of FIG. 1. Likewise, although the method 5000 of FIG. 5 can be implemented to process a SQL query, the present disclosure contemplates other non-limiting aspects, wherein the method 5000 of FIG. 5 can be implemented to process queries scripted in alternate languages, such as SchemeQL, LINQ, ScalaQL, ScalaQuery, SqlStatement, ActiveRecord, and/or HaskellDB, amongst others.

According to the non-limiting aspect of FIG. 5, the method 5000 can include identifying 5002 a parameter of the query and generating 5004 a plurality of input vectors based on the parameter of the SQL query. The method 5000 of FIG. 5 can further include transmitting 5006 the plurality of input vectors to an input layer of a neural network, such as input layer 2001 of the neural network model 2000 of FIG. 2. Subsequently, the method 5000 can include receiving 5008 the plurality of input vectors from a neural network, after the input layer converted the plurality of input vectors into a hidden state based on a plurality of randomly initialized weights. An output layer of the neural network—such as the output layer 2003 of the neural network model 2000 of FIG. 2—can be configured to generate a predicted number of rows based on a descent gradient of the neural network. Thus, the method 5000 can further include receiving 5010 the predicted number of rows from the output layer of the neural network. According to some non-limiting aspects, the method 5000 can include modifying 5012 one or more parameters of the query based on the predicted number of rows. For example, the modified parameter can be configured to reduce computational resources required to generate a query result and/or improve an accuracy of the query result.

It shall be further appreciated that the method 5000 of FIG. 5 is not limited to the depicted steps. For example, according to some non-limiting aspects, the method 5000 can further include adjusting the randomly initialized weights based on the optimized descent gradient, wherein the adjusting the randomly initialized weights is configured to improve an accuracy of the predicted number of rows. According to still other non-limiting aspects, the neural network model 2000 of FIG. 2 can use aggregated data either provided by the user or generated by the neural network model 2000 itself to improve the generated result. For example, the predicted number of rows can be one of a plurality of predicted number of rows generated by the neural network. The method 5000, therefore, can further include calculating a percentage error based on the plurality of predicted number of rows. According to other non-limiting aspects, adjusting of the randomly initialized weights can be based on the MAPE. In some non-limiting aspects, modifying the parameter of the query based on the predicted number of rows can be autonomously determined and implemented via a component of the system 1000 of FIG. 1. For example, the user device 1002 of the system 1000 of FIG., via an application stored in the memory 1006, may be configured to autonomously modify the query based on the results generated by the dynamic prediction generator 1003, thereby providing a technological improvement without human intervention to reduce the amount of computations resources required to process the query. According to some other non-limiting aspects, the parameter of the query identified can include at least one of a table used in the query, a condition applied in the query, or an output of the query. According to some other non-limiting aspects, the method 5000 can further include receiving an optimized descent gradient generated by a backpropagation algorithm of the neural network. For example, the optimized descent gradient can be configured to minimize an error between the predicted number of rows and a target value number of rows. Additionally, the target value number of rows can be based on training data provided to the neural network.

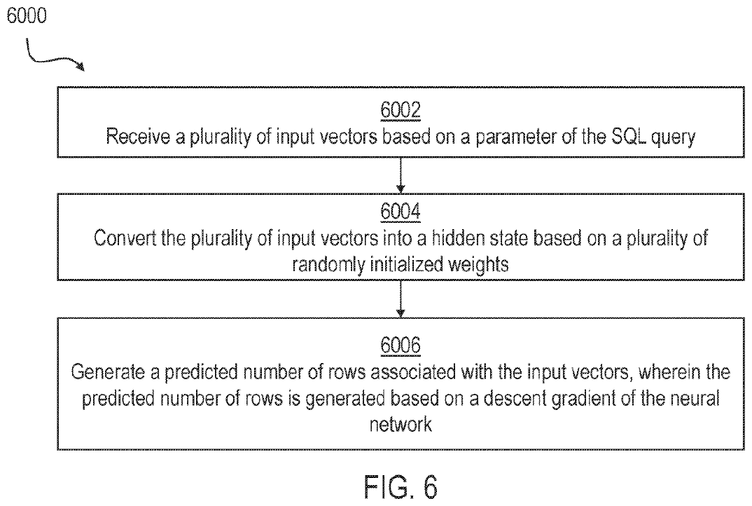

Referring now to FIG. 6, another computer-implemented method 6000 of processing a query is depicted in accordance with at least one aspect of the present disclosure. For example, the method 5000 can be performed via the processor 1005 in response to a neural network model stored in the memory 1007 of the dynamic prediction generator 1003 of the system 1000 of FIG. 1. However, according to other non-limiting aspects, one or more steps of the method 6000 of FIG. 6 can be performed by any other components of the system 1000 of FIG. 1. Likewise, although the method 6000 of FIG. 6 can be implemented to process a SQL query, the present disclosure contemplates other non-limiting aspects, wherein the method 6000 of FIG. 6 can be implemented to process queries scripted in alternate languages, such as SchemeQL, LINQ, ScalaQL, ScalaQuery, SqlStatement, ActiveRecord, and/or HaskellDB, amongst others.

According to the non-limiting aspect of FIG. 6, the method 6000 can include receiving 6002 a plurality of input vectors based on a parameter of the query. Specifically, an input layer of a neural network, such as input layer 2001 of the neural network model 2000 of FIG. 2, can be configured to receive the plurality of input vectors. Thus, the method 6000 can further include converting 6004 the plurality of input vectors into a hidden state based on a plurality of randomly initialized weights. According to some non-limiting aspects, the conversion can be performed by the an input layer and/or one or more intermediate layers of the neural network. The method 6000 can further include generating 6006 a predicted number of rows associated with the input vectors. According to some non-limiting aspects, the prediction can be generated by an output layer of a neural network, such as the output layer 2003 of the neural network model 2000 of FIG. 2. As previously described, the predicted number of rows can be generated based on a descent gradient of the neural network. Additionally, the parameter of the query can be modified based on the predicted number of rows, which can reduce the computational resources required to generate the query result and/or improve an accuracy of the query result. According to still other non-limiting aspects, the method 6000 can include optimizing the descent gradient to minimize the loss of predictions generated by the neural network model 2000 of FIG. 2. For example, according to some non-limiting aspects, the optimization can be based on a stochastic gradient descent optimization algorithm. Accordingly, the method 6000 can further include adjusting the plurality of randomly initialized weights based on the optimized descent gradient, wherein the plurality of randomly initialized weights can improve an accuracy of the predicted number of rows.

Referring now to FIG. 7, a block diagram of a computer apparatus 7000 with data processing subsystems or components, according to at least one aspect of the present disclosure. The subsystems shown in FIG. A are interconnected via a system bus 7010. Additional subsystems such as a printer 7018, keyboard 7026, fixed disk 7028 (or other memory comprising computer readable media), monitor 7022, which is coupled to a display adapter 7020, and others are shown. Peripherals and input/output (I/O) devices, which couple to an I/O controller 7012 (which can be a processor or other suitable controller), can be connected to the computer system by any number of means known in the art, such as a serial port 7024. For example, the serial port 7024 or external interface 7030 can be used to connect the computer apparatus to a wide area network such as the Internet, a mouse input device, or a scanner. The interconnection via system bus allows the central processor 7016 to communicate with each subsystem and to control the execution of instructions from system memory 7014 or the fixed disk 7028, as well as the exchange of information between subsystems. The system memory 7014 and/or the fixed disk 7028 may embody a computer readable medium.

Referring now to FIG. 8, a diagrammatic representation of an example system 8000 that includes a host machine 8002 within which a set of instructions to perform any one or more of the methodologies discussed herein may be executed, according to at least one aspect of the present disclosure. In various aspects, the host machine 8002 operates as a standalone device or may be connected (e.g., networked) to other machines. In a networked deployment, the host machine 8002 may operate in the capacity of a server or a client machine in a server-client network environment, or as a peer machine in a peer-to-peer (or distributed) network environment. The host machine 8002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 8000 includes the host machine 8002, running a host operating system (OS) 8004 on a processor or multiple processor(s)/processor core(s) 8006 (e.g., a central processing unit (CPU), a graphics processing unit (GPU), or both), and various memory nodes 8008. The host OS 8004 may include a hypervisor 8010 which is able to control the functions and/or communicate with a virtual machine (“VM”) 8012 running on machine readable media. The VM 8012 also may include a virtual CPU or vCPU 8014. The memory nodes 8008 may be linked or pinned to virtual memory nodes or vNodes 8016. When the memory nodes 8008 are linked or pinned to a corresponding vNode 8016, then data may be mapped directly from the memory nodes 8008 to the corresponding vNode 8016.

All the various components shown in host machine 8002 may be connected with and to each other, or communicate to each other via a bus (not shown) or via other coupling or communication channels or mechanisms. The host machine 8002 may further include a video display, audio device or other peripherals 8018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 8020 (also referred to as disk drive unit), and a network interface device 8022. The host machine 8002 may further include a data encryption module (not shown) to encrypt data. The components provided in the host machine 8002 are those typically found in computer systems that may be suitable for use with aspects of the present disclosure and are intended to represent a broad category of such computer components that are known in the art. Thus, the system 8000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 8024 also may be a Solid-state Drive (SSD), a hard disk drive (HDD) or other includes a computer or machine-readable medium on which is stored one or more sets of instructions and data structures (e.g., data/instructions 8026) embodying or utilizing any one or more of the methodologies or functions described herein. The data/instructions 8026 also may reside, completely or at least partially, within the main memory nodes 8008 and/or within the processor(s) 8006 during execution thereof by the host machine 8002. The data/instructions 8026 may further be transmitted or received over a network 8028 via the network interface device 8022 utilizing any one of several well-known transfer protocols (e.g., Hyper Text Transfer Protocol (HTTP)).

The processor(s) 8006 and memory nodes 8008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 8002 and that causes the host machine 8002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 8002, with each server 8030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A computer-implemented method of processing a Structured Query Language (SQL query, the method including identifying, by a processor, a parameter of the SQL query, generating, by the processor, a plurality of input vectors based on the parameter of the SQL query, transmitting, by the processor, the plurality of input vectors to an input layer of a neural network, receiving, by the processor, a predicted number of rows associated with the input vectors generated by an output layer of the neural network, wherein the predicted number of rows is generated based on a descent gradient of the neural network, and modifying, by the processor, the parameter of the SQL query based on the predicted number of rows to generate a modified parameter, wherein the modified parameter is configured to reduce computational resources required to generate an SQL query result, and wherein the modified parameter is configured to improve an accuracy of the SQL query result.

Clause 2. The computer-implemented according to clause 1, wherein the parameter of the SQL query identified by the processor includes at least one of a table used in the SQL query, a condition applied in the SQL query, or an output of the SQL query, or combinations thereof.

Clause 3. The computer-implemented method according to either of clauses 1 or 2, further including receiving, by the processor, an optimized descent gradient generated by a backpropagation algorithm of the neural network, wherein the optimized descent gradient is configured to minimize an error between the predicted number of rows and a target value number of rows, and wherein the target value number of rows is based on training data provided to the neural network.

Clause 4. The computer-implemented method according to any of clauses 1-3, further including adjusting, by the processor, a randomly initialized weight of the neural network based on the optimized descent gradient, wherein adjusting the randomly initialized weight is configured to improve an accuracy of the predicted number of rows.

Clause 5. The computer-implemented method according to any of clauses 1-4, wherein the predicted number of rows is one of a plurality of predicted number of rows generated by the neural network, and wherein the method further includes calculating, via the processor, a mean absolute percentage error (MAPE) based on the plurality of predicted number of rows, and wherein the adjusting of the randomly initialized weight is based on the MAPE.

Clause 6. The computer-implemented method according to any of clauses 1-5, wherein the modifying of the parameter of the SQL query based on the predicted number of rows is autonomously determined and implemented via the processor.

Clause 7. The computer-implemented method according to any of clauses 1-6, wherein the neural network includes a multi-layer perceptron (MLP) model.

Clause 8. A system configured to process a Structured Query Language (SQL) query, the system including a dynamic prediction generator including a processor and a memory configured to store a neural network model, and a user device including a processor and a memory, wherein the memory is configured to store instructions that, when executed by the processor, cause the user device to identify a parameter of the SQL query, generate a plurality of input vectors based on the parameter of the SQL query, transmit the plurality of input vectors to an input layer of the neural network, receive a predicted number of rows associated with the plurality of input vectors from an output layer of the neural network, wherein the predicted number of rows is generated based on a descent gradient of the neural network and a hidden state generated by an intermediate layer of the neural network, and modify the parameter of the SQL query based on the predicted number of rows to generate a modified parameter, wherein the modified parameter is configured to reduce computational resources required to generate an SQL query result, and wherein the modified parameter is configured to improve an accuracy of the SQL query result.

Clause 9. The computer-implemented method according to clause 8, wherein the parameter of the SQL query identified by the processor includes at least one of a table used in the SQL query, a condition applied in the SQL query, or an output of the SQL query, or combinations thereof.

Clause 10. The computer-implemented method according to either of clauses 8 or 9, wherein, when executed by the processor, the instructions further cause the user device to receive an optimized descent gradient generated by a backpropagation algorithm of the neural network, wherein the optimized descent gradient is configured to minimize an error between the predicted number of rows and a target value number of rows, and wherein the target value number of rows is based on training data provided to the neural network.

Clause 11. The computer-implemented method according to any of clauses 8-10, wherein, when executed by the processor, the instructions further cause the user device to adjust a randomly initialized weight of the neural network based on the optimized descent gradient, wherein adjusting the randomly initialized weight is configured to improve an accuracy of the predicted number of rows.

Clause 12. The computer-implemented method according to any of clauses 8-11, wherein the predicted number of rows is one of a plurality of predicted number of rows generated by the neural network, and wherein, when executed by the processor, the instructions further cause the user device to calculate a mean absolute percentage error (MAPE) based on the plurality of predicted number of rows, and wherein the adjusting of the randomly initialized weight is based on the MAPE.

Clause 13. The computer-implemented method according to any of clauses 8-12, wherein modifying of the parameter of the SQL query based on the predicted number of rows is autonomously determined and implemented via the processor.

Clause 14. The computer-implemented method according to any of clauses 8-13, wherein the neural network includes a multi-layer perceptron (MLP) model.

Clause 15. A computer-implemented method of processing a Structured Query Language (SQL) query, the method including receiving, by an input layer of a neural network, a plurality of input vectors based on a parameter of the SQL query, converting, by an intermediate layer of the neural network, the plurality of input vectors into a hidden state based on a plurality of randomly initialized weights, wherein the plurality of randomly initialized weights are determined based on a descent gradient of the neural network, and generating, by an output layer of the neural network, a predicted number of rows based on the hidden state, generating a recommendation to modify the SQL query based on the predicted number of rows, and transmitting the recommendation to a processor, wherein an implementation of the recommendation improves the SQL query result.

Clause 16. The computer-implemented method according to clause 15, further including generating, by a backpropagation algorithm of the neural network, an optimized descent gradient configured to minimize an error between the predicted number of rows and a target value number of rows, and wherein the target value number of rows is based on training data provided to the neural network.

Clause 17. The computer-implemented method according to either of clauses 15 or 16, further including adjusting, by a processor, the plurality of randomly initialized weights based on the optimized descent gradient, wherein adjusting the plurality of randomly initialized weights is configured to improve an accuracy of the predicted number of rows.

Clause 18. The computer-implemented method according to any of clauses 15-17, wherein the predicted number of rows is one of a plurality of predicted number of rows generated by the neural network, and wherein the method further includes calculating, via the processor, a mean absolute percentage error (MAPE) based on the plurality of predicted number of rows, and wherein adjusting the plurality of randomly initialized weights is based on the MAPE.

Clause 19. The computer-implemented method according to any of clauses 15-18, further including generating, by a processor, a modified parameter of the SQL query based on the recommendation, wherein the modified parameter is configured to reduce computational resources required to generate an SQL query result.

Clause 20. The computer-implemented method according to any of clauses 15-18, further including autonomously implementing, by the processor, the modified parameter of the SQL query, and executing, by the processor, the SQL query with the modified parameter.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer-implemented method of processing a Structured Query Language (SQL query, the method comprising:
identifying, by a processor, a parameter of the SQL query;
generating, by the processor, a plurality of input vectors based on the parameter of the SQL query;
transmitting, by the processor, the plurality of input vectors to an input layer of a neural network;
receiving, by the processor, a predicted number of rows associated with the input vectors generated by an output layer of the neural network, wherein the predicted number of rows is generated based on a descent gradient of the neural network; and
modifying, by the processor, the parameter of the SQL query based on the predicted number of rows to generate a modified parameter, wherein the modified parameter is configured to reduce computational resources required to generate an SQL query result, and wherein the modified parameter is configured to improve an accuracy of the SQL query result.

2. The computer-implemented method of claim 1, wherein the parameter of the SQL query identified by the processor comprises at least one of a table used in the SQL query, a condition applied in the SQL query, or an output of the SQL query, or combinations thereof.

3. The computer-implemented method of claim 1, further comprising:
receiving, by the processor, an optimized descent gradient generated by a backpropagation algorithm of the neural network, wherein the optimized descent gradient is configured to minimize an error between the predicted number of rows and a target value number of rows, and wherein the target value number of rows is based on training data provided to the neural network.

4. The computer-implemented method of claim 3, further comprising:
adjusting, by the processor, a randomly initialized weight of the neural network based on the optimized descent gradient, wherein adjusting the randomly initialized weight is configured to improve an accuracy of the predicted number of rows.

5. The computer-implemented method of claim 4, wherein the predicted number of rows is one of a plurality of predicted number of rows generated by the neural network, and wherein the method further comprises calculating, via the processor, a mean absolute percentage error (MAPE) based on the plurality of predicted number of rows, and wherein the adjusting of the randomly initialized weight is based on the MAPE.

6. The computer-implemented method of claim 1, wherein the modifying of the parameter of the SQL query based on the predicted number of rows is autonomously determined and implemented via the processor.

7. The computer-implemented method of claim 1, wherein the neural network comprises a multi-layer perceptron (MLP) model.

8. A system configured to process a Structured Query Language (SQL) query, the system comprising:
a dynamic prediction generator comprising a processor and a memory configured to store a neural network model; and
a user device comprising a processor and a memory, wherein the memory is configured to store instructions that, when executed by the processor, cause the user device to:
identify a parameter of the SQL query;
generate a plurality of input vectors based on the parameter of the SQL query;
transmit the plurality of input vectors to an input layer of the neural network;
receive a predicted number of rows associated with the plurality of input vectors from an output layer of the neural network, wherein the predicted number of rows is generated based on a descent gradient of the neural network and a hidden state generated by an intermediate layer of the neural network; and
modify the parameter of the SQL query based on the predicted number of rows to generate a modified parameter, wherein the modified parameter is configured to reduce computational resources required to generate an SQL query result, and wherein the modified parameter is configured to improve an accuracy of the SQL query result.

9. The system of claim 8, wherein the parameter of the SQL query identified by the processor comprises at least one of a table used in the SQL query, a condition applied in the SQL query, or an output of the SQL query, or combinations thereof.

10. The system of claim 8, wherein, when executed by the processor, the instructions further cause the user device to:
receive an optimized descent gradient generated by a backpropagation algorithm of the neural network, wherein the optimized descent gradient is configured to minimize an error between the predicted number of rows and a target value number of rows, and wherein the target value number of rows is based on training data provided to the neural network.

11. The system of claim 10, wherein, when executed by the processor, the instructions further cause the user device to:
adjust a randomly initialized weight of the neural network based on the optimized descent gradient, wherein adjusting the randomly initialized weight is configured to improve an accuracy of the predicted number of rows.

12. The system of claim 11, wherein the predicted number of rows is one of a plurality of predicted number of rows generated by the neural network, and wherein, when executed by the processor, the instructions further cause the user device to:
calculate a mean absolute percentage error (MAPE) based on the plurality of predicted number of rows, and wherein the adjusting of the randomly initialized weight is based on the MAPE.

13. The system of claim 8, wherein modifying of the parameter of the SQL query based on the predicted number of rows is autonomously determined and implemented via the processor.

14. The system of claim 8, wherein the neural network comprises a multi-layer perceptron (MLP) model.

15. A computer-implemented method of processing a Structured Query Language (SQL) query, the method comprising:
receiving, by an input layer of a neural network, a plurality of input vectors based on a parameter of the SQL query;
converting, by an intermediate layer of the neural network, the plurality of input vectors into a hidden state based on a plurality of randomly initialized weights, wherein the plurality of randomly initialized weights are determined based on a descent gradient of the neural network; and
generating, by an output layer of the neural network, a predicted number of rows based on the hidden state;
generating a recommendation to modify the SQL query based on the predicted number of rows; and
transmitting the recommendation to a processor, wherein an implementation of the recommendation improves the SQL query result.

16. The computer-implemented method of claim 15, further comprising:
generating, by a backpropagation algorithm of the neural network, an optimized descent gradient configured to minimize an error between the predicted number of rows and a target value number of rows, and wherein the target value number of rows is based on training data provided to the neural network.

17. The computer-implemented method of claim 16, further comprising:
adjusting, by a processor, the plurality of randomly initialized weights based on the optimized descent gradient, wherein adjusting the plurality of randomly initialized weights is configured to improve an accuracy of the predicted number of rows.

18. The computer-implemented method of claim 17, wherein the predicted number of rows is one of a plurality of predicted number of rows generated by the neural network, and wherein the method further comprises calculating, via the processor, a mean absolute percentage error (MAPE) based on the plurality of predicted number of rows, and wherein adjusting the plurality of randomly initialized weights is based on the MAPE.

19. The computer-implemented method of claim 15, further comprising:
generating, by a processor, a modified parameter of the SQL query based on the recommendation, wherein the modified parameter is configured to reduce computational resources required to generate an SQL query result.

20. The computer-implemented method of claim 19, further comprising:
autonomously implementing, by the processor, the modified parameter of the SQL query; and
executing, by the processor, the SQL query with the modified parameter.
